(19) United States
(12) Patent Application Publication
(10) Pub. No.: US 2012/0086275 A1
(43) Pub. Date: Apr. 12, 2012

(54) CONTROL CIRCUITRY FOR RECEIVING POWER ON ELECTRONIC DEVICES AND COMPUTERS

(76) Inventor: Manjirnath CHATTERJEE, San Francisco, CA (US)

(21) Appl. No.: 13/174,519

(22) Filed: Jun. 30, 2011

Related U.S. Application Data
(60) Provisional application No. 61/392,453, filed on Oct. 12, 2010.

(51) Int. Cl. H02J 1/10

(52) U.S. Cl. 307/52

(57) ABSTRACT

A switching OR buck power receiver or receiving circuit is provided for electronic devices. The power receiver or power receiving circuit includes a plurality of power input lines arranged in parallel, a controller, and a buck circuit element. Each power input line is connectable to a corresponding power source, and further includes a switching element.

### RELATED APPLICATIONS

This application claims benefit of priority to Provisional U.S. Patent Application No. 61/392,453, entitled SWITCHING OR BUCK POWER SUPPLY, filed on Oct. 12, 2010; the aforementioned priority application being hereby incorporated by reference in its entirety.

### TECHNICAL FIELD

The disclosed embodiments relate to control circuitry for receiving power on electronic devices and computers.

### BACKGROUND

FIG. 1 illustrates a power receiving circuit for use on a device that can receive power from multiple sources, according to prior art. For a given electronic device, an OR-receiving circuit 100 includes diode elements 110 that individually extend to various power sources (not shown) that are connected to nodes A, B, and C. The combination of diode element 110 can receive power multiple sources. If only one power source is present, the circuit 100 receives power from that source. If multiple power sources are present, the circuit 100 is configured to select and receive power from one of the power sources (e.g., the one with the highest voltage).

With reference to FIG. 2, conventional circuits 100, such as described with FIG. 1, are also configured to include regulators 120 to manage the voltage on the output node 112. The output node 112 can be structured to include voltage that is present in moments when power is switched from one source to another. Specifically, if a switch occurs from one source to another, the circuit 100 is configured to accomplish the switch without a voltage drop occurring on the output of the circuit 100. The voltage present on node 112 at the time of the switch can be regulated by a regulator 120 to reduce voltage or power drop resulting from the switch of the power sources.

With use of the regulator 120, a device can utilize power input from different sources, which may exist at different voltages. The regulator 120 can, for example, regulate input power from different sources to a voltage level required by the device (e.g., 3 volts for many small form factor devices).

Diode elements 110 typically incur voltage drop which is inefficient, and can result in the generation of heat and other detrimental effects. To avoid such problems, many circuits employ ideal diode circuits 140. Ideal diode circuits are exemplified by FIG. 3. The ideal diode circuit 140 includes a controller 142 and a switching element 144 (e.g., FET), which is positioned in the circuit with the diode element 110. The controller 142 senses the voltage at nodes 141, and causes the switching element 144 to be (i) closed when the diode element 110 (implemented in FIG. 3 as an ideal diode circuit) is on, and (ii) open when the diode element 110 is off. Many applications utilize a linear diode controller 142 to implement FIG. 3. The position of the switching element 144 handles the voltage drop that would otherwise be present from the diode element 110.

The descriptions provided with respect to FIGS. 1 through 3, however, have various shortcomings. Among them, the use of the OR switch can result in conflict when voltages are present on multiple lines. Furthermore, circuits such as required, typically require voltage regulators.

For example, FIG. 4 illustrates a linear voltage regulator 180 under a conventional approach. The linear voltage generator 180 includes a reference voltage generator 182, which generates the reference voltage at the input node 183. A series pass element 184 (e.g., a transistor) is positioned to effect a drop across the pass element to a desired output voltage (e.g., drop from 5 volts to 3 volts). An error correction amplifier 188 may be incorporated with the series pass element 184. While the linear voltage regulator 180 is a simple and stable structure, it has some drawbacks, such as its tendency to generate heat as it is designed to cause a voltage drop against a pass element.

FIG. 5 illustrates a switch and buck voltage regulator under a conventional design. Ideal diode circuits may be substituted as a variation. In FIG. 5, the regulator is formed by a switch 192 (e.g., FET), an idealized diode 193, an induction element 194, and a capacitive element 196. The load is represented by resistor 198. When the switch 192 is closed, the power source 191 charges the induction element 194 and the capacitive element 196 to the desired output voltage. When the switch 192 is open, the load draws charge from the capacitive element 196. The result is that a high load can be regulated using a relatively high switching speed, while a low load can be regulated using a relatively low switching speed.

### BRIEF DESCRIPTION OF THE DRAWINGS

FIG. 1 illustrates an OR-ing power input line design, under a conventional approach.

FIG. 2 illustrates an OR-ing power input line and regulator for receiving and regulating power input from multiple input sources, under conventional design.

FIG. 3 illustrates an ideal diode circuit for use with an OR-ing power input line design, under a conventional approach.

FIG. 4 illustrates a linear voltage regulator, under a conventional design.

FIG. 5 illustrates a switch and buck voltage regulator under conventional design.

FIG. 6A through FIG. 6C illustrate a switching OR buck supply circuit for use on electronic devices that can receive power from multiple sources, according to one or more embodiments.

FIG. 7 illustrates a control switch for use with an embodiment such as described with FIG. 6A through FIG. 6C.

FIG. 8 illustrates a variation in which a freewheel diode is used as a variation or alternative to a switch in the buck portion of circuit 200, according to an embodiment.

### DETAILED DESCRIPTION

According to some embodiments, a switching OR buck power supply (which can also be called an OR-ing buck convertor) is described to provide several benefits or advantages for controlling circuitry for receiving power.

Embodiments described herein include a power receiver or power receiving circuit that includes a plurality of power input lines arranged in parallel, a controller, and a buck circuit element. Each power input line is connectable to a corresponding power source, and further includes a switching element. The controller is configured to detect a voltage at an input of the switching element of each power input line. The controller determines which of the plurality of switching elements are to be switched on or off based at least in part on the detected voltage at the input of each of the switching elements. The buck circuit element includes components that buck a voltage at an output node of the plurality of power input lines.

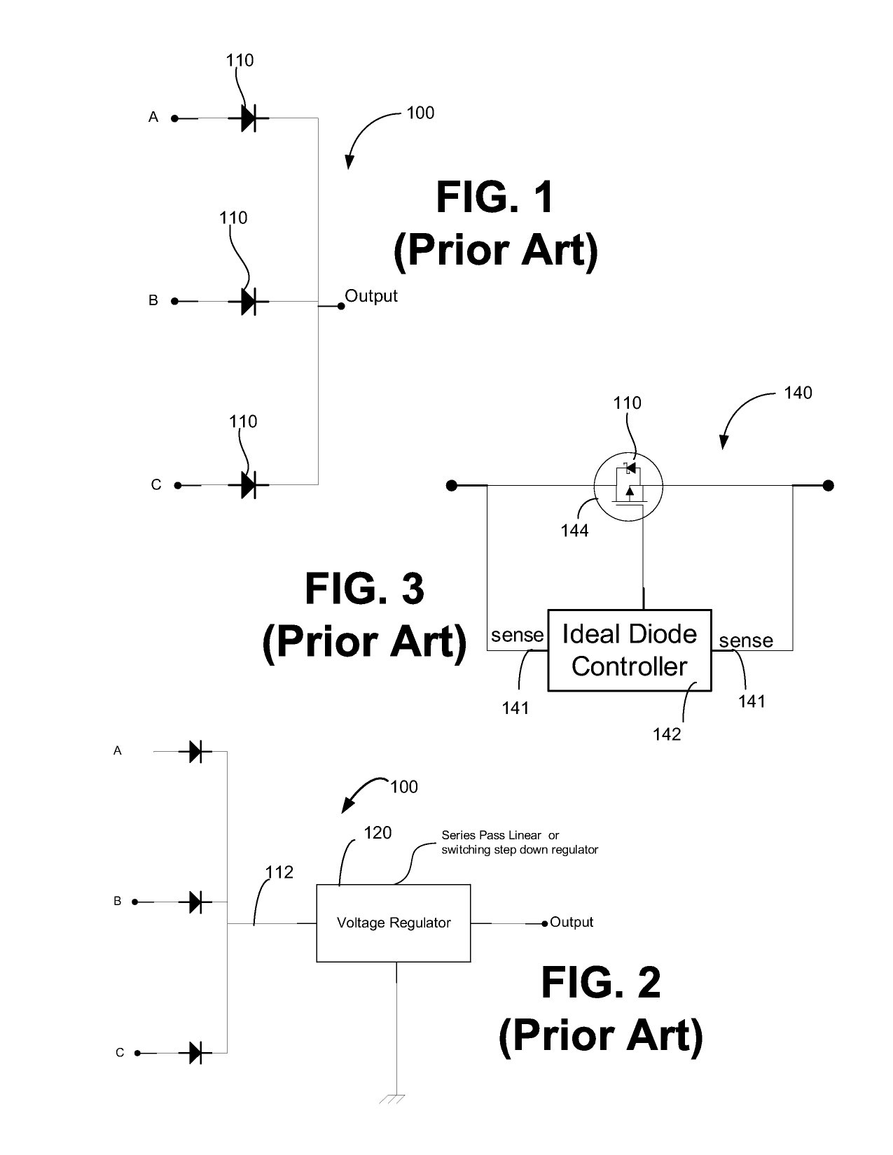

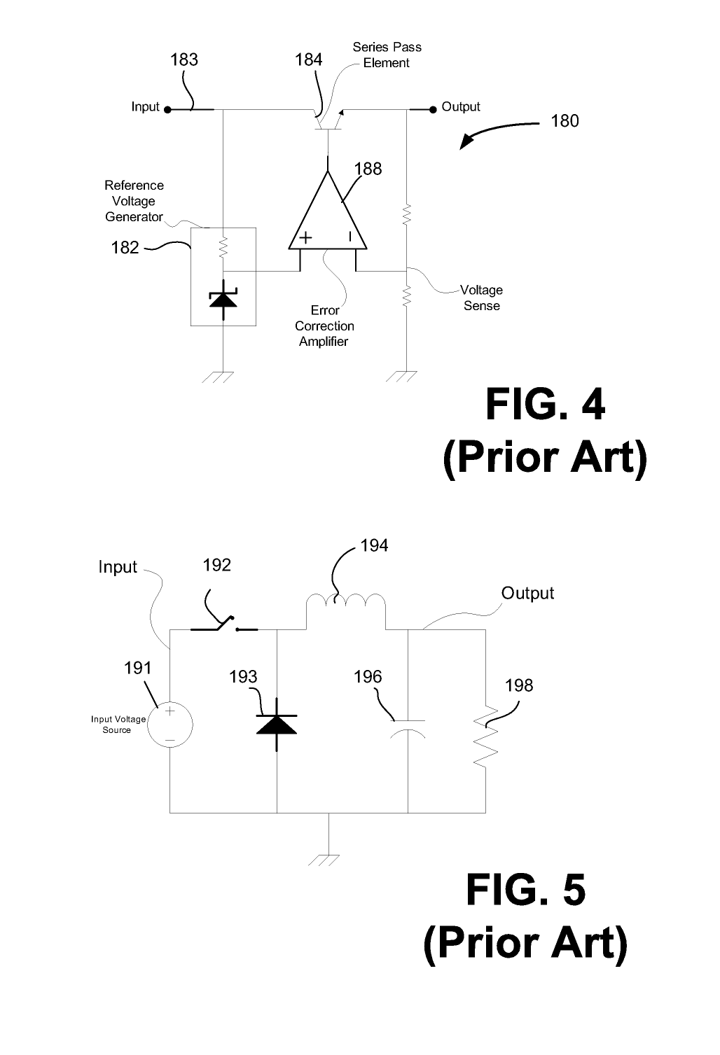

Among some benefit provided by embodiments described herein, a switching OR-ing buck power supply circuit is provided that enhances power transfer efficiencies over conventional approaches such as described with FIG. 1 through FIG. 5. Voltage drops across real world pass elements are avoided, reducing the presence of unwanted characteristics such as parasitic charges.

Furthermore, in contrast to ideal diode circuits, points of indecision or avoided or eliminated. Under conventional designs that use ideal diode circuits, points of indecision occur when the voltage drop across the pass element (e.g. FET) on a given diode or element becomes small (e.g., less than a particular threshold). Additionally, embodiments recognize that ideal diode circuits can also have momentary latching, which causes chatter a reverse current flow between various input power supplies.

Additionally, as described herein, embodiments include a switching OR-ing buck power supply circuit that enable switching between anyone of multiple input power supplies, on a per cycle basis. In such embodiments, an incorrect selection of a power input source can be corrected on a very next cycle with no detrimental effects.

According to embodiments described herein, an ideal-diode OR circuits can be integrated with switching buck or low-drop-out regulators to combine power sources and form a unified stable power supply. Embodiments recognize that the use of such circuits can be greatly improved by combining aspects of switching power supplies to physically multiplex the input supplies with minimal energy loss. Embodiments described herein are (i) efficient in total use electronic switching devices, and (ii) inherently stable from a control systems analysis point of view.

Among other benefits, embodiments described herein (i) enable maximum power transfer efficiency—minimize drops in real world pass elements and parasitic; (ii) minimize or avoid indecision inherent in “ideal diode” circuits, such as provided in prior art, which can occur when the voltage drop across a pass FET on the diode OR become small; (iii) minimize or avoid momentarily latching, which can causing either chatter or reverse current flow between the various input power supplies; and/or (iv) enable true sharing and decision correction so that if any one of multiple input supplies is incorrectly selected at a particular cycle, it can be corrected on the next cycle.

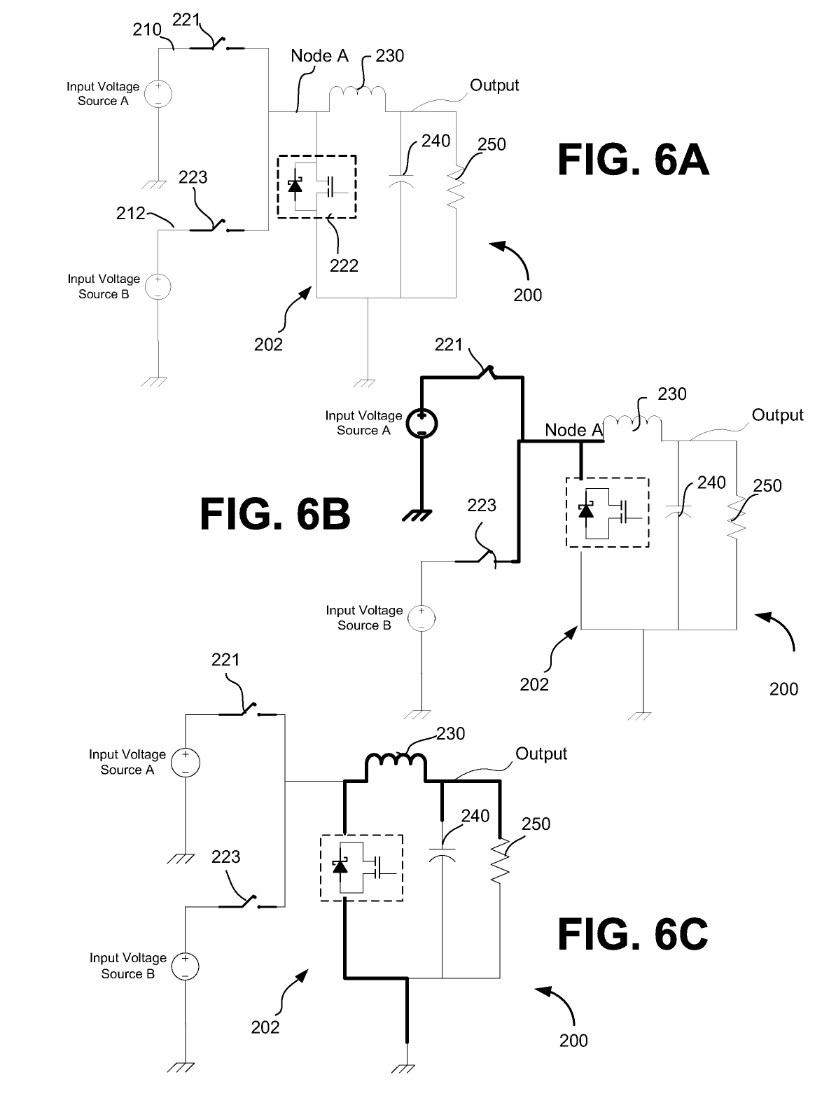

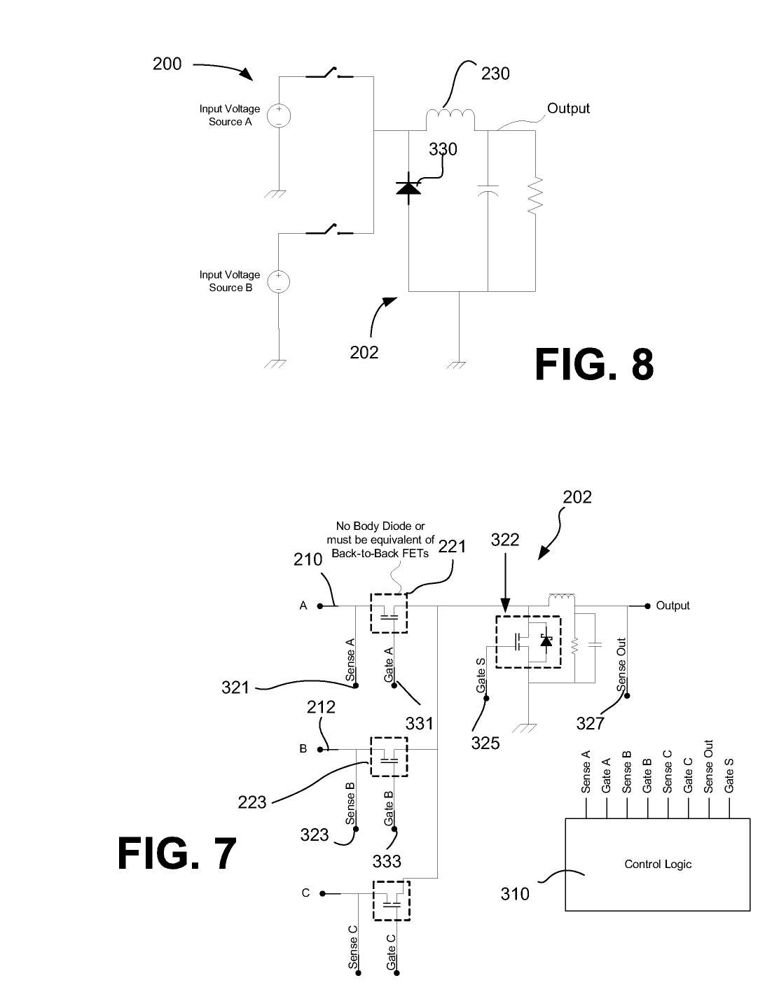

FIG. 6A through FIG. 6C illustrate a combined switching OR buck supply circuit for use on electronic devices that can receive power from multiple sources, according to one or more embodiments. FIG. 6A through FIG. 6C depicts a synchronous switching embodiment in which any of multiple power inputs can be used to supply power on a per cycle basis. Switching logic (see FIG. 7) may be used to evaluate which power sources can be used to supply power at each sample period. Depending on logic and other implementation factors, a single source may be selected per cycle basis, or alternatively, multiple power sources may be selected at a given interval. The pulse wave modulation of the circuit 200 can vary dependent on the output load and an input to output voltage differential. The switching frequency can also be modulated to reduce unwanted effects such as EMI.

According to an embodiment, the switching logic includes logic for minimum error recovery time proportion to 1/Fs, where Fs is the switching frequency. This allows the output to survive a time period (by proper L/C component selection) when the input does not provide any power (e.g. when the wrong input line is selected, such as by false reading). The correction will occur in the next cycle. In implementation, the pulse wave modulation (PWM) may have to increase to accommodate the lost power cycle, but this is transparent to the output.

According to an embodiment, a switching OR buck circuit 200 includes multiple power input lines 210, 212 aligned in parallel to provide an input node to a buck portion (or buck circuit element) 202 of the circuit. Each power input line 210, 212 includes a switching element 221, 223, respectively, that is controlled by logic (as described with an embodiment of FIG. 7). The number of input lines 210, 212 can vary depending on design and implementation (e.g., there may be additional input lines for additional power sources). In one implementation, the switching element(s) 210, 212 may correspond to a Field Effect Transistor (FET). In variations, the switching element(s) 210, 212 may correspond to a Bipolar Junction Transistor (BPT) or Insulated Gate Bipolar Transistor (IGBT).

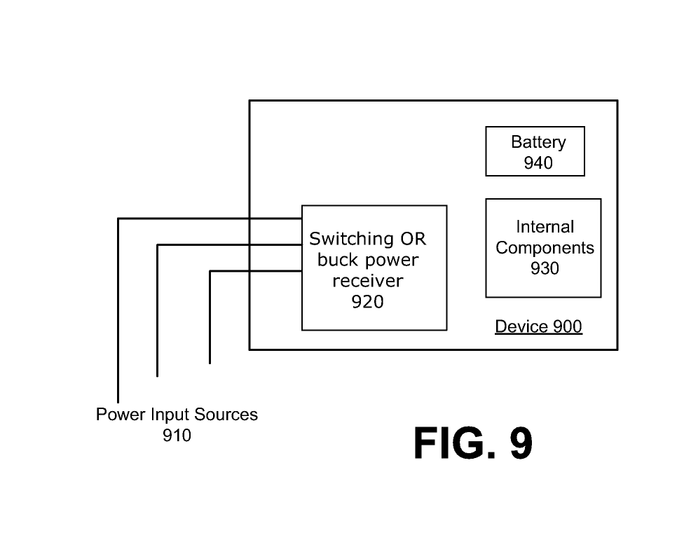

The buck portion 202 includes a switching element 222 (or alternatively a diode element, as described with FIG. 8), an inductor component 230, a capacitor component 240, and a load 250. As mentioned, logic is used to control the switching elements 221, 223 on the power input lines 210, 212. The switches 221, 223 collectively operate on a duty cycle. In one implementation, the logic senses, on each duty cycle, the input voltage on each power input line 210, 212 to determine (i) the best power source (e.g., when a single power source is to be selected), or (ii) which power sources are suitable (when multiple power sources can be selected). Suitable sources may correspond to those that provide voltage that is above a particular threshold criteria, such as those that provide voltage above a particular level that is deemed useful. When the best power source is identified on a given duty cycle, the power input line 210, 212 for the selected power source is closed, and the switches of the one or more other power input lines 210, 212 are opened (e.g., if power source coupled to input line 210 is selected, switch 221 is closed and switch 223 is open). This determination can be made on a cycle by cycle basis. The voltage of the node A is thus based on the voltage of the input source selected on a particular duty cycle.

The buck portion 202 of circuit 200 includes the inductor component 230 and capacitor component 240, which are charged by voltage supplied to the node A by one of the power input lines 210, 212. As an example, in FIG. 6B, the darkened lines represent the switching element 221 closing as a result of the logic selecting the power supply on the power input line 210. When the switching element 221 closes, the other switching element(s) 223 are open. The input voltage node A supplies voltage to the buck portion 202 of the circuit 200.

The circuit 200 operates on a duty cycle (e.g., 2 MHz), so that the switching element 221 is closed. When the switching elements 221, 223 are opened in the next cycle, no power is being received by node A from the input lines 210, 212. In this portion of the duty cycle, FIG. 6C illustrates the inductor element 230 and the capacitor element 240 being used to supply power to the load 250. In the next cycle, the power input voltage can charge the inductor and capacitor elements 230, 240. The inductor and capacitor elements 230, 240 serve to buck the voltage at node A when the duty cycle is on, and regulate the output to the load 250 when the duty cycle is off. Larger loads can be handled by increasing the duty cycle of the circuit 200.

Among other benefits, embodiments such as described include inherent corrective capabilities for instances when the selected power input line 210, 212 is actually not the best source of power. For example, the power input lines 210, 212 can include a parasitic value that causes a false sensing of the power input. Given the timed decay discharge of the inductor component 230 and the capacitor component 240, the buck portion 202 can compensate for instances when the logic selects to close the wrong switching element 221, 223.

Furthermore, an embodiment such as described by FIG. 6A through FIG. 6C and elsewhere in this application enable use of fewer components, and reduce complexity and unwanted effects such as heat generation.

FIG. 7 illustrates a control switch for use with an embodiment such as described with FIG. 6A through FIG. 6C. A controller 310 (or control logic 310) can make determinations or selections as to which of the switching elements 210, 212 are to be closed. The closed switching elements 221, 223 are those that are selected to supply power from corresponding power source(s). According to an embodiment, controller 310 senses the voltage at the input of each switching element 221, 223 via sense 321, 323. Each switching element 221, 223 also includes a gate line 331, 333 which carries a signal to open or close the particular switching element. The controller 310 implements logic to open/close switching elements based on schemes such as (i) best available selection, in which at each cycle, the power input line 210, 212, carrying the highest voltage is selected to supply power to the circuit; or (ii) load sharing, in which each power source that is suitable (e.g., determined to provide voltage that is above a threshold) is selected to supply power.

Furthermore, according to an embodiment, the buck portion 202 includes a switching element 322 (e.g. FET) that is positioned to maintain the charge of the inductor element 230. The controller 310 can control the switching element using gate signal 325 and sense input 327 that is based on a voltage output (indicating state of inductive element 230).

FIG. 8 illustrates a variation in which a freewheel diode is used as a variation or alternative to a switch in the buck portion of circuit 200, according to an embodiment. A freewheeling diode 330 may be used to handle reverse current from the inductor element 230 when no power is supplied to the buck portion 202 of the circuit 200 (e.g. when the duty cycle is between cycles).

FIG. 9 illustrates an electronic device that incorporates a switching OR buck power receiver, such as described with embodiments of FIG. 6A through FIG. 6C, FIG. 7 and FIG. 8. In FIG. 9, an electronic device 900 is connected to multiple input power sources 910, and further incorporates a switching OR buck power receiver 920. The electronic device 900 can correspond to anyone of a possible set of devices, such as a mobile computing device (e.g. laptop, tablet, cellular telephony device), personal computer, consumer electronic device (e.g. camera, GPS device, media player), and/or server. The electronic device 900 can receive power from multiple sources 910, which can optionally include different power signal mediums (e.g. connector medium, wall outlet, wireless charging etc.). For example, large computer such as servers may require redundant power supplies, which are checked to identify best source, or can be used in tandem to load share. Smaller portable devices can incorporate power sources from wall outlets, connector ports (e.g. USB drives) and the like. Some small form factor devices can also use power input from sources such as wireless charging adapters 910A (e.g. those that use induction or magnetism to convey power).

Power received through the receiver 920 is used to power one or more internal components 930 of the device 900. In some implementations, the input power is used to charge a battery 940 and/or power components 930 such as memory or processing resources.

With such implementations, some embodiments enable the switching OR buck power receiver 920 to identify the single best power source on a per cycle basis. Other embodiments may enable load sharing among multiple suitable power sources. For example, a mobile computing device may use power supply sources from the connector and a wireless charging dock. [0038] In embodiments in which the power supply is switched from one source to another, the switching OR buck power receiver 920 minimizes the voltage drop when the switching occurs. Furthermore, if the determination on a particular cycle is incorrect (e.g. a false sense reading), the per cycle basis enables the correct selection to be made on the very next cycle, thereby eliminating or reducing any negative effects from selecting the wrong power source.

Extensions and Variations

According to an embodiment, a system (or device) can be configured to include multiple power inlets, multiple power receiver circuits and multiple loads. Each power receiver circuit can be configured in accordance with one or more embodiments described herein. In addition to power receiver circuits, the system can include control logic for selecting one of the power inlets for one of the loads. The control logic may synchronize the user of the various power receiver circuits to enable power inlet/load pairing and load sharing. For example, a system or device may include multiple power inlets A, B, C (each connecting to different power supplies), multiple receiver circuits, and control logic associated with each power receiver circuit.

According to some embodiment, the control logic associated with each power receiver circuit may be centralized or synchronized. The control logic for one receiver circuit may select, for example, power inlet B for the load handled by that receiver circuit, but if both B and C are above minimum necessary voltage (e.g. criteria), then another receiver circuit for another load may pull power from C to maintain load sharing. In this respect, multiple receiver circuits may operate in synchronized fashion to load share and use power supplied with synchronized logic.

Embodiments described herein include individual elements and concepts described herein, independently of other concepts, ideas or systems, as well as combinations of elements recited anywhere in this application. Although illustrative embodiments of the invention have been described in detail with reference to the accompanying drawings, it is to be understood that the described embodiments are not limited to those precise embodiments, but rather include modifications and variations as provided. Furthermore, a particular feature described either individually or as part of an embodiment can be combined with other individually described features, or parts of other embodiments, even if the other features and embodiments make no mention of the particular feature.

Embodiments described herein include individual elements and concepts described herein, independently of other concepts, ideas or systems, as well as combinations of elements recited anywhere in this application. Although illustrative embodiments of the invention have been described in detail with reference to the accompanying drawings, it is to be understood that the described embodiments are not limited to those precise embodiments, but rather include modifications and variations as provided. Furthermore, a particular feature described either individually or as part of an embodiment can be combined with other individually described features, or parts of other embodiments, even if the other features and embodiments make no mention of the particular feature.

What is claimed is:

1. A power receiver comprising:
a plurality of power input lines arranged in parallel, each power input line being connectable to a corresponding power source;
wherein each of the plurality of power input lines include a switching element;
a controller that detects a voltage at an input of the switching element of each power input line, and to determine which of the plurality of switching elements are to be switched on based at least in part on the detected voltage at the input of each of the switching elements; and
a buck circuit element that is configured to buck a voltage at an output node of the plurality of power input lines.

2. The power receiver of claim 1, wherein the controller is configured to select one of the plurality of switching elements to switch on, based on the voltage supplied by the corresponding power source being the highest.

3. The power receiver of claim 1, wherein the controller is configured to select multiple switching elements in the plurality of switching elements to switch on, based on the voltage supplied of each of the corresponding power sources being above a threshold criteria.

4. The power receiver of claim 1, wherein one or more of the plurality of switching elements corresponds to a Field Effect Transistor.

5. The power receiver of claim 1, wherein one or more of the plurality of switching elements corresponds to a Bipolar Junction Transistor.

6. The power receiver of claim 1, wherein one or more of the plurality of switching elements corresponds to an Insulated Gate Bipolar Transistor.

7. The power receiver of claim 1, wherein the plurality of power input lines include power input lines that are connectable to different kinds of power signal mediums.

8. The power receiver of claim 7, wherein at least one of the plurality of power input lines is connectable to a wireless power signal medium.

9. The power receiver of claim 1, wherein the buck circuit element includes an inductor element.

10. The power receiver of claim 1, wherein the one buck circuit element includes a freewheeling diode element.

11. The power receiver of claim 1, wherein the buck circuit element includes a switching element that is synchronously operated with the switching elements of the plurality of power input lines.

12. An electronic device comprising:
one or more internal components that receive power from an external source;
a power receiver that is configured to connect to anyone of a plurality of power sources, wherein the power receiver comprises:
a plurality of power input lines arranged in parallel, each power input line being connectable to a corresponding power source;
wherein each of the plurality of power input lines include a switching element;
a controller that detects a voltage at an input of the switching element of each power input line, and to determine which of the plurality of switching elements are to be switched on based at least in part on the detected voltage at the input of each of the switching elements; and
one or more buck circuit components that buck a voltage at an output node of the plurality of power input lines.

13. The electronic device of claim 12, wherein the one or more internal components include a rechargeable battery.

14. The electronic device of claim 12, wherein the electronic device corresponds to a device selected from a laptop or netbook, a tablet, a cellular telephony device, a consumer electronic device, or a server.

15. The power receiver of claim 12, wherein the controller is configured to select one of the plurality of switching elements to switch on, based on the voltage supplied by the corresponding power source being the highest.

16. The power receiver of claim 12, wherein the controller is configured to select multiple switching elements in the plurality of switching elements to switch on, based on the voltage supplied of each of the corresponding power sources being above a threshold criteria.

17. The power receiver of claim 12, wherein each of the plurality of switching elements corresponds to a Field Effect Transistor.

18. The power receiver of claim 12, wherein one or more of the plurality of switching elements corresponds to a Bipolar Junction Transistor.

19. The power receiver of claim 12, wherein one or more of the plurality of switching elements corresponds to an Insulated Gate Bipolar Transistor.

20. The power receiver of claim 12, wherein the power receiver includes power input lines that are connectable to different kinds of power signal mediums.
